(19) United States
(12) Patent Application Publication
(10) Pub. No.: US 2025/0113111 A1
(43) Pub. Date: Apr. 3, 2025

(54) LENS SHADING CORRECTION (LSC) IN VARIABLE APERTURE (VA) CAMERA SYSTEMS

(71) Applicant: QUALCOMM Incorporated, San Diego, CA (US)

(72) Inventors: Kai Liu, Taipei (TW); Wen-Chun Feng, New Taipei City (TW); Zhongshan Wang, Shenzhen (CN); Chung-Yan Chih, Taipei (TW)

(21) Appl. No.: 18/729,040

(22) PCT Filed: Mar. 21, 2022
(86) PCT No.: PCT/CN2022/081898

§ 371 Date: Jul. 15, 2024

(51) Int. Cl. H04N 25/61; G06T 7/20; H04N 23/71; H04N 23/75

(52) U.S. Cl. CPC H04N 25/61; G06T 7/20; H04N 23/71; H04N 23/75

(57) ABSTRACT

This disclosure provides systems, methods, and devices for image processing that support enhanced variable aperture (VA) camera operations. In a first aspect, a method of image processing includes determining first image statistics for first image data representing a first scene captured at a first aperture; and determining whether the first image data satisfies a first criteria. When the first image data satisfies the first criteria, the image processing includes determining an updated lens shading correction (LSC) corresponding to the first aperture based on the first image statistics and on a current LSC corresponding to the first aperture; and determining a first output image frame based on the updated LSC and the first image data. Other aspects and features are also claimed and described.

### TECHNICAL FIELD

Aspects of the present disclosure relate generally to image processing, and more particularly, to lens shading correction (LSC). Some features may enable and provide improved image processing, including reducing variation in photograph at different aperture sizes.

### INTRODUCTION

Image capture devices are devices that can capture one or more digital images, whether still image for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

Camera modules of the image capture device may include components such as a lens, an aperture, and an image sensor. Different configurations of the lens, aperture, and image sensor can produce different representations of the same scene. Variations in manufacturing and assembly of the lens, aperture, image sensor, and other components can also result in different representations of the same scene being recorded by different equipment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A camera module may have a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The same camera module may have different characteristics based on the current aperture size. For example, the lens shading effect may be different across different aperture settings. A dynamic lens shading correction (LSC) compensation for an image capture device with variable aperture (VA) camera module may be based on the aperture size and calibrated data available for some aperture sizes that are less than all available aperture sizes. The dynamic LSC may include generation of LSC gain tables for different apertures and updating the LSC gain tables as image data is collected and analyzed for a corresponding aperture size. Although examples of image processing for image data captured from a variable aperture (VA) camera system are described, aspects of the disclosure may be applied to any variable optical system that can change the amount of light captured by an image sensor.

In one aspect of the disclosure, a method for image processing includes determining first image statistics for first image data representing a first scene captured at a first aperture; determining an updated lens shading correction (LSC) corresponding to the first aperture based on the first image statistics and on a current LSC corresponding to the first aperture; and/or determining a first output image frame based on the updated LSC and the first image data. In some embodiments, the determining of the updated LSC may be performed only when the first image data satisfies a first criteria. The first criteria may include whether motion is detected in the scene represented by the first image data. In some embodiments, the updated LSC may be based on pre-calibrated for the camera system capturing the first image data. In some embodiments, the updated LSC may be based on pre-calibrated data, the first image data, statistics of the first image data, second image data (e.g., image data for another scene), and/or statistics of the second image data.

In an additional aspect of the disclosure, an apparatus includes at least one processor and a memory coupled to the at least one processor. The at least one processor is configured to perform operations including determining first image statistics for first image data representing a first scene captured at a first aperture; determining an updated lens shading correction (LSC) corresponding to the first aperture based on the first image statistics and on a current LSC corresponding to the first aperture; and/or determining a first output image frame based on the updated LSC and the first image data. In some embodiments, the determining of the updated LSC may be performed only when the first image data satisfies a first criteria. The first criteria may include whether motion is detected in the scene represented by the first image data. The apparatus may be an image capture device with a variable aperture (VA) camera module, such as a mobile phone.

In an additional aspect of the disclosure, an apparatus includes means for determining first image statistics for first image data representing a first scene captured at a first aperture; means for determining an updated lens shading correction (LSC) corresponding to the first aperture based on the first image statistics and on a current LSC corresponding to the first aperture; and/or means for determining a first output image frame based on the updated LSC and the first image data.

In an additional aspect of the disclosure, a non-transitory computer-readable medium stores instructions that, when executed by a processor, cause the processor to perform operations. The operations include determining first image statistics for first image data representing a first scene captured at a first aperture; determining an updated lens shading correction (LSC) corresponding to the first aperture based on the first image statistics and on a current LSC corresponding to the first aperture; and/or determining a first output image frame based on the updated LSC and the first image data. In some embodiments, the determining of the updated LSC may be performed only when the first image data satisfies a first criteria. The first criteria may include whether motion is detected in the scene represented by the first image data.

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

In general, this disclosure describes image processing techniques involving digital cameras having image sensors and image signal processors (ISPs). The ISP may be configured to control the capture of image frames from one or more image sensors and process one or more image frames from the one or more image sensors to generate a view of a scene in a corrected image frame. A corrected image frame may be part of a sequence of image frames forming a video sequence. The video sequence may include other image frames received from the image sensor or other images sensors and/or other corrected image frames based on input from the image sensor or another image sensor. In some embodiments, the processing of one or more image frames may be performed within the image sensor, such as in a binning module. The image processing techniques described in embodiments disclosed herein may be performed by circuitry, such as a binning module, in the image sensor, in the image signal processor (ISP), in the application processor (AP), or a combination or two or all of these components.

In an example, the image signal processor may receive an instruction to capture a sequence of image frames in response to the loading of software, such as a camera application, to produce a preview display from the image capture device. The image signal processor may be configured to produce a single flow of output frames, based on images frames received from one or more image sensors. The single flow of output frames may include raw image data from an image sensor, binned image data from an image sensor, or corrected image frames processed by one or more algorithms, such as in a binning module, within the image signal processor. For example, an image frame obtained from an image sensor, which may have performed some processing on the data before output to the image signal processor may be processed in the image signal processor by processing the image frame through an image post-processing engine (IPE) and/or other image processing circuitry for performing one or more of tone mapping, portrait lighting, contrast enhancement, gamma correction, etc.

After an output frame representing the scene is determined by the image signal processor using the image correction, such as binning described in various embodiments herein, the output frame may be displayed on a device display as a single still image and/or as part of a video sequence, saved to a storage device as a picture or a video sequence, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, frames for object tracking, etc.). In other examples, the image signal processor may output frames of the image data to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. That is, the image signal processor may obtain incoming frames from one or more image sensors, each coupled to one or more camera lenses, and, in turn, may produce and output a flow of output frames to various output destinations.

In some aspects, the corrected image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The apparatus may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in as a recording or as streaming data, over a first network connection of a plurality of network connections; and a processor coupled to the first network adaptor, and the memory. The processor may cause the transmission of corrected image frames described herein over a wireless communications network such as a 5G NR communication network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors according to one or more aspects of the disclosure.

FIG. 2 shows an example image signal processor (ISP) configuration for performing lens shading correction (LSC) for a variable aperture (VA) camera module according to some aspects of the disclosure.

FIG. 3 is a flow chart illustrating an example method for applying lens shading correction (LSC) based on image statistics according to some embodiments of the disclosure.

FIG. 4 is a flow chart illustrating an example method for updating a lens shading correction (LSC) based on certain criteria according to some embodiments of the disclosure.

FIG. 5 is a flow chart illustrating an example method for updating a lens shading correction (LSC) based on detection of motion in a scene according to some embodiments of the disclosure.

FIG. 6 is a flow chart illustrating an example method for updating a lens shading correction (LSC) with motion region post-processing according to some embodiments of the disclosure.

FIG. 7 is a graph illustrating updating of a lens shading correction (LSC) according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

During an image capture operation, the aperture of the camera may change based on device control, user request, changing conditions, and/or other events. The aperture changes may lead to different lens shading effects and a photograph that does not accurately represent the scene. The lens shading effect changes may occur based on different interactions of the light with the various elements of the camera, e.g., lens, aperture, and/or image sensor.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

The present disclosure provides systems, apparatus, methods, and computer-readable media that support improved lens shading correction (LSC) operations for compensating for change in a representation of the scene as a result of changing aperture of the camera acquiring the image data representing the scene. The LSC operation involves updating the LSC correction operation for an aperture size based on image data collected by the image sensor at that aperture size. Thus, the LSC operation is customized for the particular camera module at the particular aperture. Differences in the camera module functionality at different apertures can thus be accounted for to produce a higher quality photograph.

Particular implementations of the subject matter described in this disclosure may be implemented to realize one or more of the following potential advantages or benefits. In some aspects, the present disclosure provides techniques for improving image appearance by reducing unusual or unexpected color changes in image data received from an image sensor and viewed by a user. Differences in the camera module functionality at different apertures can be accounted for by updating the LSC to produce a higher quality photograph. Additionally, generation of a preview during a change in aperture of a VA image capture system using aspects of this disclosure may display smoother transitions in real-time aperture switching.

An example device for capturing image frames using one or more image sensors, such as a smartphone, may include a configuration of two, three, four, or more cameras on a backside (e.g., a side opposite a user display) or a front side (e.g., a same side as a user display) of the device. Devices with multiple image sensors include one or more image signal processors (ISPs), Computer Vision Processors (CVPs) (e.g., AI engines), or other suitable circuitry for processing images captured by the image sensors. The one or more image signal processors may provide processed image frames to a memory and/or a processor (such as an application processor, an image front end (IFE), an image processing engine (IPE), or other suitable processing circuitry) for further processing, such as for encoding, storage, transmission, or other manipulation.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including or coupled to two or more image sensors capable of capturing image frames (or “frames”). Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

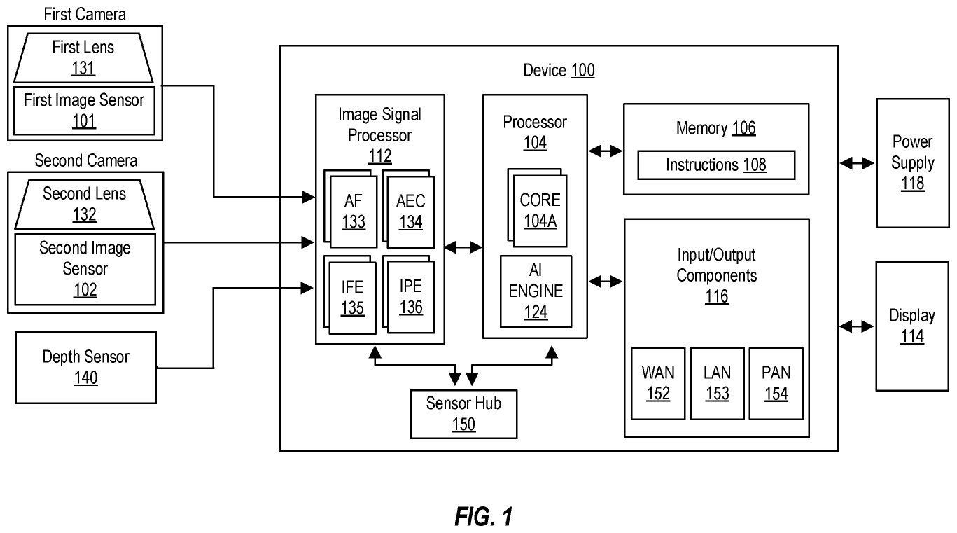

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first and second camera, respectively. In another embodiment, a wire interface couples the image signal processor 112 to an external image sensor. In a further embodiment, a wireless interface couples the image signal processor 112 to the image sensor 101, 102.

The first camera may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112 and output from the depth sensors processed in a similar manner to that of image sensors 101 and 102. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), and/or one or more auto exposure compensation (AEC) 134 engines. The AF 133, AEC 134, AFE 135, APE 136 may each include application-specific circuitry, be embodied as software code executed by the ISP 112, and/or a combination of hardware within and software code executing on the ISP 112. The ISP 112 may additionally execute an automatic white balancing (AWB) engine for performing white balancing operations. The AWB engine may execute in, for example, the image front ends (IFEs) 135 or other dedicated or general processing circuitry within the ISP 112 or the image capture device 100, such as on a digital signal processor (DSP).

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise reduction operations. For example, execution of the instructions can instruct the image signal processor 112 to begin or end capturing an image frame or a sequence of image frames, in which the capture includes noise reduction as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, the camera application may receive a command to begin a video preview display upon which a video comprising a sequence of image frames is captured and processed from one or more image sensors 101 or 102. Image correction, such as with cascaded IPEs, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124) in addition to the ability to execute software to cause the device 100 to perform a number of functions or operations, such as the operations described herein. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

In some embodiments of an image capture device, the first camera and/or second camera may support variable aperture (VA) operation, allowing the aperture to vary during the capture of image data. In some embodiments, the image processing described herein may be performed separate from the capture of the image data, such as when aspects of the image processing described herein are performed after acquiring the image data.

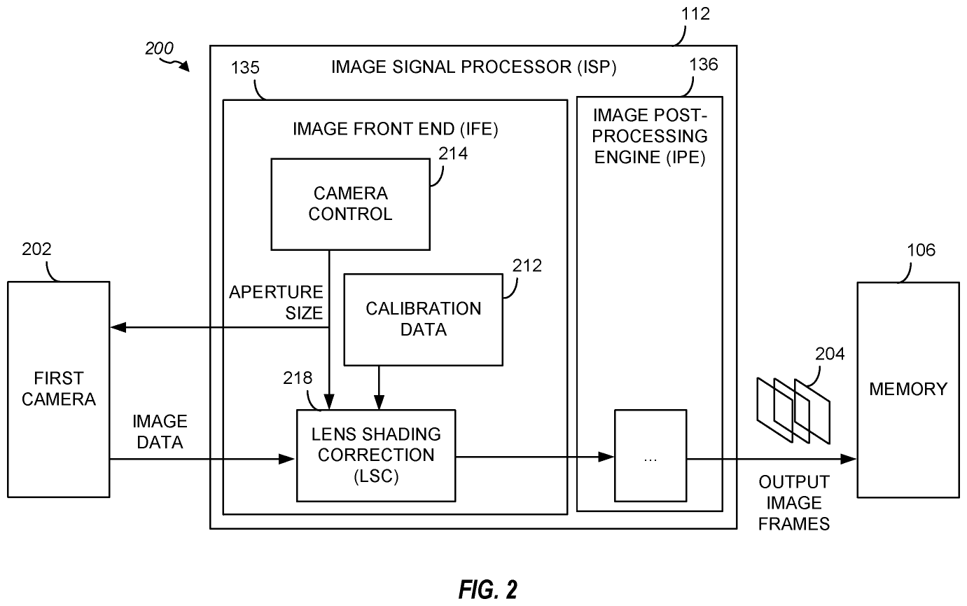

FIG. 2 shows an example image signal processor (ISP) configuration for performing lens shading correction (LSC) for a variable aperture (VA) camera module according to some aspects of the disclosure. A camera 202 provides image data to a processor, such as the image signal processor (ISP) 112. The image data may be processed in an image front end (IFE) 135 to apply corrections or enhancements to the image data captured by the camera 202. One example processing is application of lens shading correction (LSC) to the image data. Lens shading correction (LSC) corrects image data for input shading image caused by a camera aperture to compensate the image brightness changes across different portions of the image and achieve a more uniform image. The light signal received by the camera 202 falls off from the image center, where the brightness is highest, to each of the corners, where the brightness is lowest. The variation in brightness is caused by lens and image sensor limitations in the camera 202. The variation is different at different aperture sizes. The lens shading correction (LSC) 218 may apply correction to the image data based on the aperture of the camera 202 producing the image data. When the camera 202 is a variable aperture (VA) camera and changes apertures, the LSC 218 may change the applied LSC. When the camera 202 changes to a different camera with a different aperture, the LSC 218 may change the applied LSC.

The camera control 214 may transmit commands to switch apertures in a variable aperture (VA) system. The aperture switch may be caused based on an algorithm that monitors the image data and automatically adjusts the aperture size without user input based on image conditions. For example, as ambient light decreases the aperture may be increased to increase image brightness. The aperture switch may alternatively or also be caused based on user input. For example, a user may manually specify an aperture in a camera application executing on the ISP 112 or another processor coupled to the ISP 112. As another example, a user may specify a camera mode, such as portrait mode, which adjusts the aperture size to obtain a desired bokeh or background blurring. The aperture size may be output from the camera control 214 to the camera 202, and also to the LSC 218, which uses the aperture size to adjust the correction applied to the image data.

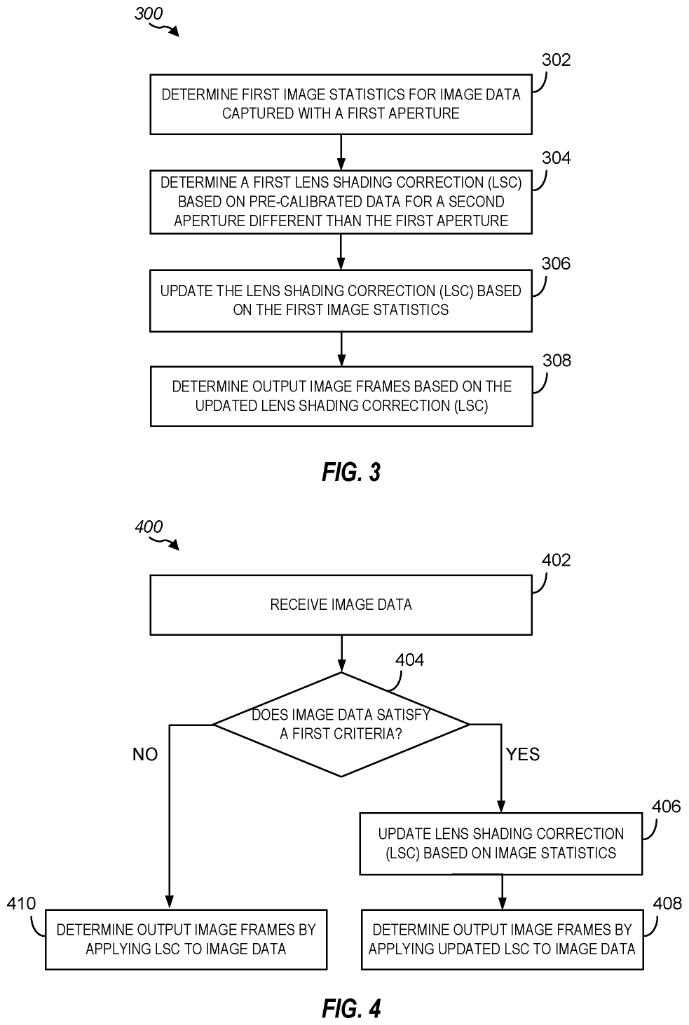

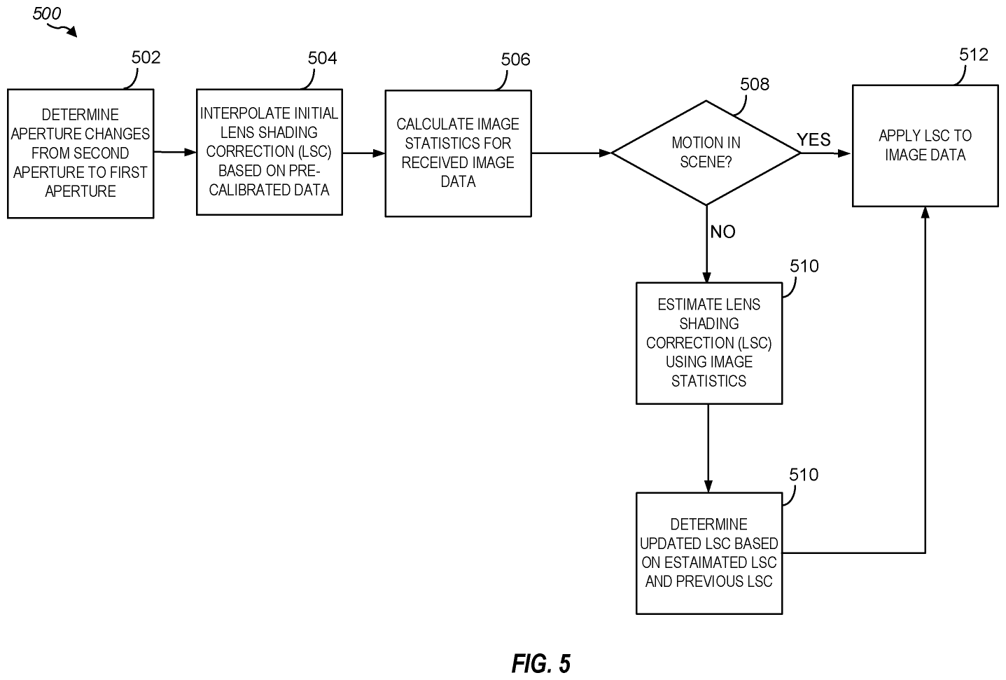

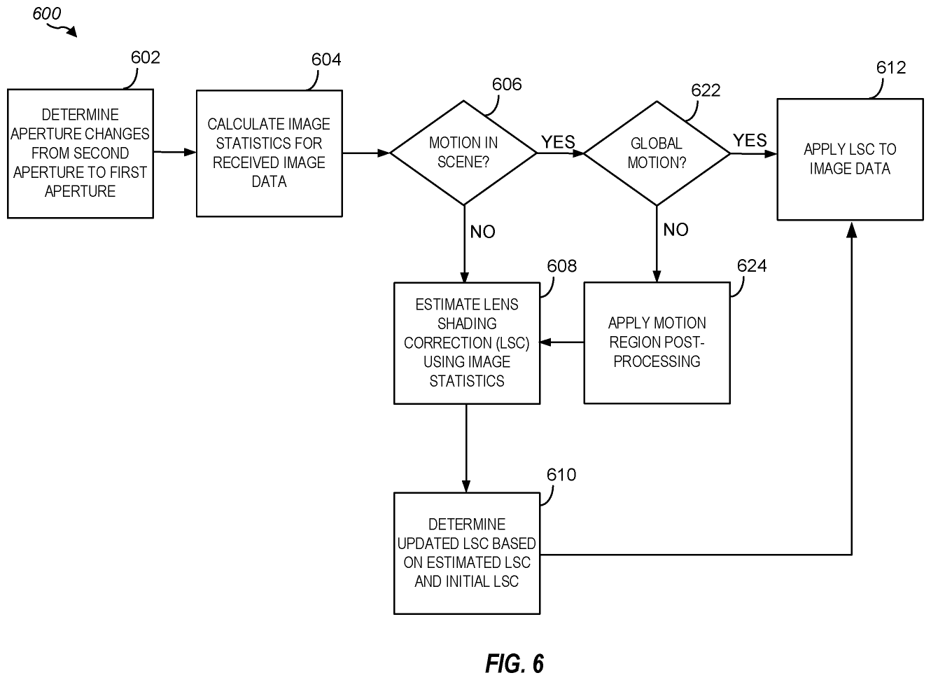

The LSC 218 may apply correction to the image data based on pre-calibrated data 212, which may be stored in memory within the IFE 135 or other memory in the system accessible by the IFE 135. Pre-calibrated data 212 may not include calibration data for every available aperture size at camera 202. The LSC 218 may use available calibration data to determine an initial LSC table by, for example, interpolating an initial LSC table for the current aperture size from calibration data for other apertures stored in pre-calibration data 212. The LSC 218 may use the image data to update the initial LSC table and replace the initial LSC table with the updated LSC table. The updates may be based on image statistics of the image data. The updates may be condition on criteria regarding the image data. For example, the LSC table may be updated only when no motion is detected in the scene. In some embodiments, when local, rather than global, motion is present in the image data, the image data may be processed and the LSC table updated based on the processed image data. The LSC 218 may perform operations described with reference to one or more of FIG. 3, FIG. 4, FIG. 5, or FIG. 6. After the image data is corrected by LSC 218, further processing of the corrected image data may be performed by operations in the image front end (IFE) 135 and/or image post-processing engine (IPE) 136 to generate output image frames 204. The output image frames 204 may be stored in memory 106 for output to a preview image on a display, output to storage in long-term storage, and/or output to network adaptor for transmission to another device or a remote server.

One method of processing image data in LSC 218 is shown in FIG. 3. FIG. 3 is a flow chart illustrating an example method for applying lens shading correction (LSC) based on image statistics according to some embodiments of the disclosure. A method 300 includes, at block 302, determining first image statistics for image data captured with a first aperture. The image statistics may include information regarding the brightness of different regions of the image. In some embodiments, the image statistics may include an array of values with each value reflecting an average brightness, or other statistical measure, for a N×N block (e.g., 3×3 block) of pixels.

At block 304, a first lens shading correction (LSC) is determined based on pre-calibrated data for a second aperture different than the first aperture. The LSC may be represented by a LSC table containing an array of values with each value representing an adjustment factor to be applied to image data from respective portions of the camera. The LSC table determined at block 304 may be estimated for the first aperture based on pre-calibrated data of an LSC table for a second aperture. For example, the LSC table determined at block 304 may be based on interpolating between an LSC table for the second aperture and a LSC table for a third aperture. The second and third apertures may be selected from those that are available in the pre-calibrated data as the closest aperture sizes to the first aperture with one larger than the first aperture and one smaller than the first aperture.

At block 306, the LSC is updated based on the first image statistics. The interpolated LSC table of block 304 may be updated based on image statistics of block 302. The image statistics may reflect the light signal fall-off from image center to image corners for the first aperture, which differs from the light signal fall-off for the second aperture and the third aperture. The image statistics may thus be used to update the estimated LSC table generated by interpolating between LSC tables for the second aperture and the third aperture.

In some embodiments, the updating of the LSC table based on image statistics may be based on a reliability of the image statistics determined at block 302. The update process for the LSC table of the first aperture may be performed based on the following equation:

$${LSC}_{n e w} = ( 1 - \frac{\# of reliable stats}{\# of total stats} ) {LSC}_{previous} + ( \frac{\# of reliable stats}{\# of total stats} ) {LSC}_{estimated} ,$$

wherein LSC_{new} is an updated LSC table, LSCₚᵣₑᵥᵢₒᵤₛ is a previous LSC table (which may be the initial LSC table interpolated from pre-calibrated data), and LSC_{estimated} is the LSC table based on the image statistics.

At block 308, output image frames are determined based on the updated LSC. In some embodiments, a first number of output image frames have LSC based on the initial LSC without updates from the image statistics. A delay corresponding to the first number of output image frames may correspond to a delay in the availability of image statistics for the image data. For example, when the aperture size changes, image data at the new aperture size may be immediately available but there may be a delay in image statistics corresponding to the image data for the new aperture size. In some embodiments, the delay may be a few frames such as three frames.

Certain criteria may indicate the image statistics do not provide accurate data for updating the LSC table, and thus the updating may only be performed based on image data that satisfy certain criteria. FIG. 4 is a flow chart illustrating an example method for updating a lens shading correction (LSC) based on certain criteria according to some embodiments of the disclosure. At block 402, image data is received and analyzed to determine, at block 404, whether the image data satisfies a first criteria. For example, the image data may be analyzed to identify motion in a scene. Motion in a scene may skew the image statistics in an area of the image data around the motion. As another example, the image data may be analyzed for an average brightness or other statistical measure. Very dim scenes may not provide sufficient contrast results in image statistics that inaccurately represent the lens shading effect of the aperture.

If the criteria are not satisfied, such when motion exists in the scene, the method 400 continues to block 410 to determine output image frames by applying the previous LSC table to the image data without updating the LSC table. If the criteria are satisfied, such as when no motion exists in the scene, the method 400 continues to block 406 to update the LSC table based on image statistics of the image data received at block 402. At block 408, output image frames are determined by applying the updated LSC of block 406 to the image data. The method of 400 may continue to repeat as additional image data is received at the same aperture.

An aperture change may trigger changing the LSC table for processing image data. FIG. 5 is a flow chart illustrating an example method for updating a lens shading correction (LSC) based on detection of motion in a scene according to some embodiments of the disclosure. A method 500 includes, at block 502, determining the aperture changes from a second aperture to a first aperture. When the aperture changes, the LSC table for the previous aperture, updated based on image statistics, may be stored in a buffer or other memory to be recalled when the camera switches back to that aperture. Thus, the LSC table may continue to be updated to improve accuracy of the correction of the lens shading effect and may continue to be updated to adjust for changes in the camera module over time.

After the aperture changes, at block 504, an initial LSC is interpolated based on pre-calibrated data. Image data may be received after the aperture change and image statistics calculated, at block 506, for the image data from the camera at the new aperture. At block 508, the processor determines whether motion is detected in the scene represented in the image data. In some embodiments, the motion detection of block 508 may be based on sensor data from the image capture device, such as accelerometer and/or gyroscope data received at the sensor hub 150 of FIG. 1. In some embodiments, the motion detection of block 508 may be based on the image statistics for the image data. For example, the image statistics may be compared to an expected profile to determine motion exists. In some embodiment, the processor may determine whether the image statistics show the lens shading effect with brighter pixels appearing in the center of the image than at the corners. When the expected profile showing lens shading effect does not appear in the image statistics, it may be determined that there is motion in the scene that makes the image statistics undesirable for updating the LSC table. In some embodiments, the processor may determine whether motion exists in the scene by determining a difference in the first image statistics between neighboring portions of the first image data, such as determining a sum of absolute differences across the image data for an image frame.

If motion is detected in the scene, the method 500 continues to block 512 to apply LSC to image data without updating the LSC table. If motion is not detected in the scene, the method 500 continues to estimate LSC using image statistics at block 510 and update the LSC based on the estimated LSC and the previous LSC (which may be the initial LSC). After updating the LSC table, the method 500 continues to block 512 to apply the updated LSC to the image data. The method 500 continues processing image data from the camera captured with the first aperture until another aperture change restarts the method at block 502.

In some embodiments, certain kinds of motion may be compensated for and allow LSC updating to continue. For example, local motion can be compensated in the image data and the compensated image data used to update the LSC. Some embodiments of LSC processing may implement operations as described with reference to FIG. 6. FIG. 6 is a flow chart illustrating an example method for updating a lens shading correction (LSC) with motion region post-processing according to some embodiments of the disclosure. A method 600 includes, at block 602, determining an aperture change from a second aperture to a first aperture, similar to described with respect to block 502. At block 602, image statistics are calculated for the image data, similar to described with respect to block 504. At blocks 606 and 622, criteria are evaluated to determine the existence of motion in the scene, and to classify the motion as local or global. In some embodiments, the processor may determine whether a difference between a number of neighboring blocks exceeds a threshold to determine whether a confidence level of motion for a block is high. The motion confidence for a block (i, j) of pixels may be calculated as:

$${motion}_{confidence} ( i , j ) = {Σ}_{m = - 1}^{1} {Σ}_{n = - 1}^{1} \frac{stats ( i , j )}{stats ( i + m , j + n )} , i , j ∈ {stats}_{table} .$$

The motion_{confidence} array may be iterated over to count a number of entries that are above a threshold value, and the count compared to a global threshold to determine if global motion exists in the image data and/or compared to a local threshold to determine if local motion exists in the image data. A lower threshold for the local threshold allows motion within the scene to be detected, and a higher threshold for the global threshold allows distinguishing scene-wide motion, such as movement of the camera module itself, from local motion, such as movement of a subject in the scene.

If no motion is detected the method 600 continues to block 608 to estimate a LSC based on the image statistics, update the LSC based on the estimated LSC at block 610, and apply the updated LSC to the image data at block 612.

If motion is detected at block 606, the processor determines if the motion is global motion or local motion at block 622. If global motion is determined at block 622, the method 600 continues to block 612 to apply the LSC to the image data without updating the LSC, which avoids the global motion from degrading the LSC. If local motion is determined at block 622, the method 600 continues to block 624 to apply motion region post-processing. Block 624 compensates for the local motion such that the LSC may be updated based on the image data. Block 624 may include smoothing, averaging, low-pass filtering, statistical analysis, or other processing to reduce the effect of the local motion on skewing image statistics. In some embodiments, the post-processing of block 624 may include determining blocks that have a high motion confidence value (such as above a threshold), and for those blocks replacing the value with an average of its eight neighbors in the image statistics. In some embodiments, the post-processing of block 624 may include determining blocks that have a high motion confidence value (such as above a threshold), and for those blocks replacing the image statistic value with a value corresponding to an initial LSC table.

After post-processing of the image statistics is performed at block 624, the method 600 continues to block 608 to determining an estimated the LSC using the processed image statistics, determining an updated LSC based on the estimated LSC, and applying the updated LSC to the image data at block 612.

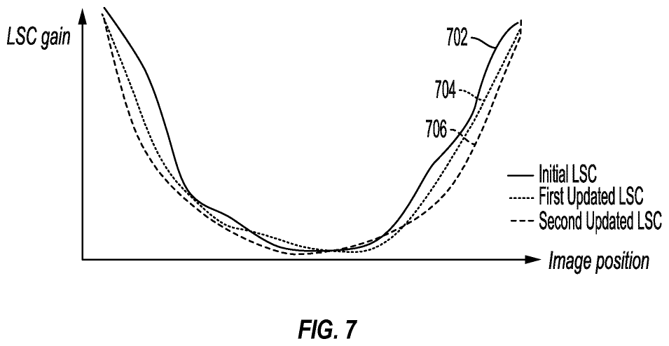

The updating of the LSC as described in embodiments of this disclosure is illustrated in FIG. 7. FIG. 7 is a graph illustrating updating of a lens shading correction (LSC) according to some embodiments of the disclosure. The graph shows a LSC gain applied to image data representing one cross-section through a line of an image frame. Line 702 shows an initial LSC gain, which may be represented as one row in a LSC table and reflect interpolated values from pre-calibration data for other apertures. The LSC of line 702 may be updated based on image statistics to obtain line 704. As further image data is collected the LSC table may be further updated to arrive at line 706. The gains illustrated in FIG. 7 may be applied by a processor to the image data by multiplying the image data values by a LSC gain corresponding to the location of the image data recorded by the image sensor. For example, image data recorded from a middle portion of the image sensor is multiplied by a smaller LSC gain according to line 706 than image data recorded from a left or right portion of the image sensor. This correction reduces unexpected color variation across a photograph and reduces artifacts such as an unexpected bright region in the photograph.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including determining first image statistics for first image data representing a first scene captured at a first aperture; determining whether the first image data satisfies a first criteria. In some aspects, when the first image data satisfies the first criteria, the operations further include determining an updated lens shading correction (LSC) corresponding to the first aperture based on the first image statistics and on a current LSC corresponding to the first aperture; and determining a first output image frame based on the updated LSC and the first image data. Additionally, the apparatus may perform or operate according to one or more aspects as described below. In some implementations, the apparatus includes a wireless device, such as a UE or BS. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the method may further include storing the updated LSC as the current LSC corresponding to the first aperture; determining second image statistics for second image data representing a second scene captured at the first aperture; and determining a second output image frame based on the updated LSC and the second image data.

In a third aspect, in combination with one or more of the first aspect or the second aspect, storing of the updated LSC as the current LSC is based on blending the updated LSC with the current LSC based on a reliability of the first image statistics.

In a fourth aspect, in combination with one or more of the first aspect through the third aspect, determining whether the first image data satisfies the first criteria comprises determining whether motion exists in the first scene.

In a fifth aspect, in combination with one or more of the first aspect through the fourth aspect, determining whether motion exists in the first scene comprises determining a difference in the first image statistics between neighboring portions of the first image data.

In a sixth aspect, in combination with one or more of the first aspect through the fifth aspect, the operations further include, when the first image data satisfies the first criteria, determining whether the motion in the first scene is global motion.

In a seventh aspect, in combination with one or more of the first aspect through the sixth aspect, the operations further include, when the motion in the first scene is not global motion: determining a statistical measure of the first image statistics, wherein determining the updated LSC is performed based on the statistical measure.

In an eighth aspect, in combination with one or more of the first aspect through the seventh aspect, the operations further include determining a change in aperture for a first camera from a second aperture to the first aperture; and receiving the first image data from the first camera at the first aperture.

In a ninth aspect, in combination with one or more of the first aspect through the eighth aspect, determining the first image statistics is based on determining the change in aperture.

In a tenth aspect, in combination with one or more of the first aspect through the ninth aspect, the operations further include determining the current LSC based on a first pre-calibrated LSC for a second aperture different from the first aperture, wherein the determining of the current LSC is performed before determining the updated lens shading correction (LSC).

In an eleventh aspect, in combination with one or more of the first aspect through the tenth aspect, determining the current LSC is based on the first pre-calibrated LSC for the second aperture different from the first aperture and on a second pre-calibrated LSC for a third aperture different from the second aperture by interpolating between the first pre-calibrated LSC and the second pre-calibrated LSC.

In a twelfth aspect, combination with one or more of the first aspect through the eleventh aspect, determining whether the first image data satisfies the first criteria comprises the operations of determining motion confidence values for the first image data based on the first image statistics; determining a count of motion confidence values above a confidence threshold; determining whether the count is above a local motion threshold; and determining whether the count is above a global motion threshold.

In a thirteenth aspect, in combination with one or more of the first aspect through the twelfth aspect, the operations further include, when the count is above a local motion threshold and below a global motion threshold, processing the first image statistics to determine processed first image statistics, wherein determining the updated LSC is based on processed first image statistics.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
determining first image statistics for first image data representing a first scene captured at a first aperture;
determining whether the first image data satisfies a first criteria; and
when the first image data satisfies the first criteria:
determining an updated lens shading correction (LSC) corresponding to the first aperture based on the first image statistics and on a current LSC corresponding to the first aperture; and
determining a first output image frame based on the updated LSC and the first image data.

2. The method of claim 1, further comprising:
storing the updated LSC as the current LSC corresponding to the first aperture;
determining second image statistics for second image data representing a second scene captured at the first aperture; and
determining a second output image frame based on the updated LSC and the second image data.

3. The method of claim 2, wherein storing the updated LSC as the current LSC is based on blending the updated LSC with the current LSC based on a reliability of the first image statistics.

4. The method of claim 1, wherein determining whether the first image data satisfies the first criteria comprises determining whether motion exists in the first scene.

5. The method of claim 4, wherein determining whether motion exists in the first scene comprises determining a difference in the first image statistics between neighboring portions of the first image data.

6. The method of claim 4, further comprising:
when the first image data satisfies the first criteria, determining whether the motion in the first scene is global motion; and
when the motion in the first scene is not global motion:
determining a statistical measure of the first image statistics,
wherein determining the updated LSC is performed based on the statistical measure.

7. The method of claim 1, further comprising:
determining a change in aperture for a first camera from a second aperture to the first aperture; and
receiving the first image data from the first camera at the first aperture,
wherein determining the first image statistics is based on determining the change in aperture.

8. The method of claim 1, further comprising:
determining the current LSC based on a first pre-calibrated LSC for a second aperture different from the first aperture, wherein the determining of the current LSC is performed before determining the updated lens shading correction (LSC).

9. The method of claim 8, wherein determining the current LSC is based on the first pre-calibrated LSC for the second aperture different from the first aperture and on a second pre-calibrated LSC for a third aperture different from the second aperture by interpolating between the first pre-calibrated LSC and the second pre-calibrated LSC.

10. The method of claim 1, wherein:
determining whether the first image data satisfies the first criteria comprises:
determining motion confidence values for the first image data based on the first image statistics;
determining a count of motion confidence values above a confidence threshold;
determining whether the count is above a local motion threshold; and
determining whether the count is above a global motion threshold; and
the method further comprising:
when the count is above a local motion threshold and below a global motion threshold, processing the first image statistics to determine processed first image statistics, wherein determining the updated LSC is based on processed first image statistics.

11. An apparatus, comprising:
a memory storing processor-readable code; and
at least one processor coupled to the memory, the at least one processor configured to execute the processor-readable code to cause the at least one processor to perform operations including:
determining first image statistics for first image data representing a first scene captured at a first aperture;
determining whether the first image data satisfies a first criteria; and
when the first image data satisfies the first criteria:
determining an updated lens shading correction (LSC) corresponding to the first aperture based on the first image statistics and on a current LSC corresponding to the first aperture; and
determining a first output image frame based on the updated LSC and the first image data.

12. The apparatus of claim 11, wherein the at least one processor is further configured to execute the processor-readable code to cause the at least one processor to perform operations including:
storing the updated LSC as the current LSC corresponding to the first aperture;
determining second image statistics for second image data representing a second scene captured at the first aperture; and
determining a second output image frame based on the updated LSC and the second image data.

13. The apparatus of claim 12, wherein storing the updated LSC as the current LSC is based on blending the updated LSC with the current LSC based on a reliability of the first image statistics.

14. The apparatus of claim 11, wherein determining whether the first image data satisfies the first criteria comprises determining whether motion exists in the first scene.

15. The apparatus of claim 14, wherein determining whether motion exists in the first scene comprises determining a difference in the first image statistics between neighboring portions of the first image data.

16. The apparatus of claim 14, wherein the at least one processor is further configured to execute the processor-readable code to cause the at least one processor to perform operations including:
when the first image data satisfies the first criteria, determining whether the motion in the first scene is global motion; and
when the motion in the first scene is not global motion:
determining a statistical measure of the first image statistics,
wherein determining the updated LSC is performed based on the statistical measure.

17. The apparatus of claim 11, wherein the at least one processor is further configured to execute the processor-readable code to cause the at least one processor to perform operations including:
determining a change in aperture for a first camera from a second aperture to the first aperture; and
receiving the first image data from the first camera at the first aperture,
wherein determining the first image statistics is based on determining the change in aperture.

18. The apparatus of claim 11, wherein the at least one processor is further configured to execute the processor-readable code to cause the at least one processor to perform operations including:
determining the current LSC based on a first pre-calibrated LSC for a second aperture different from the first aperture, wherein the determining of the current LSC is performed before determining the updated lens shading correction (LSC).

19. The apparatus of claim 18, wherein determining the current LSC is based on the first pre-calibrated LSC for the second aperture different from the first aperture and on a second pre-calibrated LSC for a third aperture different from the second aperture by interpolating between the first pre-calibrated LSC and the second pre-calibrated LSC.

20. The apparatus of claim 11, further comprising a variable aperture (VA) camera module, wherein the at least one processor comprises an image signal processor (ISP).

21. A non-transitory computer-readable medium storing instructions that, when executed by a processor, cause the processor to perform operations comprising:
determining first image statistics for first image data representing a first scene captured at a first aperture;
determining whether the first image data satisfies a first criteria; and
when the first image data satisfies the first criteria:
determining an updated lens shading correction (LSC) corresponding to the first aperture based on the first image statistics and on a current LSC corresponding to the first aperture; and
determining a first output image frame based on the updated LSC and the first image data.

22. The non-transitory, computer-readable medium of claim 21, wherein the instructions, when executed by a processor, cause the processor to perform further operations comprising:
storing the updated LSC as the current LSC corresponding to the first aperture;
determining second image statistics for second image data representing a second scene captured at the first aperture; and
determining a second output image frame based on the updated LSC and the second image data.

23. The non-transitory, computer-readable medium of claim 22, wherein storing the updated LSC as the current LSC is based on blending the updated LSC with the current LSC based on a reliability of the first image statistics.

24. The non-transitory, computer-readable medium of claim 21, wherein determining whether the first image data satisfies the first criteria comprises determining whether motion exists in the first scene.

25. The non-transitory, computer-readable medium of claim 24, wherein determining whether motion exists in the first scene comprises determining a difference in the first image statistics between neighboring portions of the first image data.

26. The non-transitory, computer-readable medium of claim 24, wherein the instructions, when executed by a processor, cause the processor to perform further operations comprising:
when the first image data satisfies the first criteria, determining whether the motion in the first scene is global motion; and
when the motion in the first scene is not global motion:
determining a statistical measure of the first image statistics,
wherein determining the updated LSC is performed based on the statistical measure.

27. The non-transitory, computer-readable medium of claim 21, wherein the instructions, when executed by a processor, cause the processor to perform further operations comprising:
determining a change in aperture for a first camera from a second aperture to the first aperture; and
receiving the first image data from the first camera at the first aperture,
wherein determining the first image statistics is based on determining the change in aperture.

28. The non-transitory, computer-readable medium of claim 21, wherein the instructions, when executed by a processor, cause the processor to perform further operations comprising:
determining the current LSC based on a first pre-calibrated LSC for a second aperture different from the first aperture, wherein the determining of the current LSC is performed before determining the updated lens shading correction (LSC).

29. The non-transitory, computer-readable medium of claim 28, wherein determining the current LSC is based on the first pre-calibrated LSC for the second aperture different from the first aperture and on a second pre-calibrated LSC for a third aperture different from the second aperture by interpolating between the first pre-calibrated LSC and the second pre-calibrated LSC.

30. The non-transitory, computer-readable medium of claim 21, wherein:
determining whether the first image data satisfies the first criteria comprises:
determining motion confidence values for the first image data based on the first image statistics;
determining a count of motion confidence values above a confidence threshold;
determining whether the count is above a local motion threshold; and
determining whether the count is above a global motion threshold; and
wherein the instructions, when executed by a processor, cause the processor to perform further operations comprising:
when the count is above a local motion threshold and below a global motion threshold, processing the first image statistics to determine processed first image statistics, wherein determining the updated LSC is based on processed first image statistics.
